(19) United States
(12) Patent Application Publication
(10) Pub. No.: US 2026/0370874 A1
(43) Pub. Date: Nov. 19, 2026

(54) Intra channel prediction

(71) Applicant: Fraunhofer-Gesellschaft zur Förderung der angewandten Forschung e.V., München (DE)

(72) Inventors: Jonathan PFAFF, Berlin (DE); Heiner KIRCHHOFFER, Berlin (DE); Christian HELMRICH, Berlin (DE); Sophie PIENTKA, Berlin (DE); Heiko SCHWARZ, Berlin (DE); Detlev MARPE, Berlin (DE); Thomas WIEGAND, Berlin (DE)

(21) Appl. No.: 19/735,759

(22) Filed: Jul. 9, 2026

Related U.S. Application Data
(63) Continuation of application No. PCT/EP2025/050708, filed on Jan. 13, 2025.

(30) Foreign Application Priority Data
Jan. 12, 2024 (EP) 24151742.4

(51) Int. Cl. H04N 19/597; H04N 19/176

(52) U.S. Cl. CPC H04N 19/597; H04N 19/176

(57) ABSTRACT

An embodiment is related to a decoder/encoder for decoding/encoding a multi-channel digital signal from/into a data stream, configured to decode/encode coded channels representing the multi-channel digital signal from/into the data stream in temporal blocks by predicting a current temporal block of a predetermined coded channel from one or more reference block portions of the predetermined coded channel.

### CROSS-REFERENCE TO RELATED APPLICATIONS

This application is a continuation of copending International Application No. PCT/EP2025/050708, filed Jan. 13, 2025, which is incorporated herein by reference in its entirety, and additionally claims priority from European Application No. 24 151 742.4, filed Jan. 12, 2024, which is incorporated herein by reference in its entirety.

### TECHNICAL FIELD

Embodiments according to the invention are related to apparatuses and methods for encoding or decoding a digital temporally-varying signal such as a channel of a multi-channel digital signal using an efficient implementation of intra prediction and to apparatuses and methods for encoding or decoding a digital time-varying signal using an efficient implementation of such intra-prediction.

### BACKGROUND OF THE INVENTION

In the following, different inventive embodiments and aspects will be described in a chapter “Basic principle of intra channel prediction using coded temporal offsets”, in a chapter “Coding of the temporal offset value”, in a chapter “Signal adaptive prediction filtering for intra channel prediction with temporal offsets”, in a chapter “Superposition of predictions using multiple temporal offsets” and in a chapter “Embodiments”.

Also, further embodiments will be defined by the enclosed claims.

It should be noted that any embodiments as defined by the claims can be supplemented by any of the details (features and functionalities) described in the above mentioned chapters.

Also, the embodiments described in the above mentioned chapters can be used individually, and can also be supplemented by any of the features in another chapter, or by any feature included in the claims.

Also, it should be noted that individual aspects described herein can be used individually or in combination. Thus, details can be added to each of said individual aspects without adding details to another one of said aspects.

It should also be noted that the present disclosure describes, explicitly or implicitly, features usable in encoder (apparatus for providing an encoded representation of an input signal). Thus, any of the features described herein can be used in the context of an encoder.

Further, it should also be noted that the present disclosure describes, explicitly or implicitly, features usable in decoder (apparatus for decoding an encoded signal). Thus, any of the features described herein can be used in the context of a decoder.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can be supplemented by any of the features and functionalities described with respect to the apparatuses.

Also, any of the features and functionalities described herein can be implemented in hardware or in software, or using a combination of hardware and software, as will be described in the section “implementation alternatives”.

Multi-channel digital signals might have a very large number of channels. Some of these channels may be locally highly correlated while others might be completely uncorrelated or even independent. Also, the signals in the different channels may not be temporally aligned with each other. This results in a complicated multi-channel coding scenario.

Additionally, the herein considered digital time-varying signals might be highly oscillatory which means that they fully exploit the allowed sample-value range within very short time intervals. This may require substantial storage and bandwidth.

Therefore, it is desired to provide concepts for rendering multi-channel signal coding and coding of digital time-varying signals more efficient. It is desired to reduce a computational complexity and a bit stream and thus a signalization cost.

### SUMMARY

An embodiment may have a decoder for decoding a multi-channel digital signal from a data stream, configured to decode coded channels representing the multi-channel digital signal from the data stream in temporal blocks by predicting a current temporal block of a predetermined coded channel from one or more reference block portions of the predetermined coded channel.

Another embodiment may have an encoder for encoding a multi-channel digital signal into a data stream, configured to encode coded channels representing the multi-channel digital signal into the data stream in temporal blocks by predicting a current temporal block of a predetermined coded channel from one or more reference block portions of the predetermined coded channel.

According to another embodiment, a method for decoding a multi-channel digital signal from a data stream may have the step of decoding coded channels representing the multi-channel digital signal from the data stream in temporal blocks by predicting a current temporal block of a predetermined coded channel from one or more reference block portions of the predetermined coded channel.

According to another embodiment, a method for encoding a multi-channel digital signal into a data stream may have the step of encoding coded channels representing the multi-channel digital signal into the data stream in temporal blocks by predicting a current temporal block of a predetermined coded channel from one or more reference block portions of the predetermined coded channel.

Another embodiment may have a data stream generated by an encoder according to the invention.

In accordance with a first aspect of the present invention, the inventors of the present application realized that one problem encountered when trying to code multi-channel digital signals stems from the fact that such signals might have a very large number of channels, wherein some of these channels may be locally highly correlated while others might be completely uncorrelated or even independent. According to the first aspect of the present application, this difficulty is overcome by using prediction methods for coding that exploit intra-channel dependencis but for which the channels can be coded independently. The inventors propose to predict a current temporal block of a predetermined coded channel of the multi-channel digital signal from one or more reference block portions of the same channel. The inventors of the present application realized that even though the signal of this channel might be highly oscillatory, which means that it fully exploits the allowed sample-value range within very short time intervals, it is advantageous to predict the current temporal block intra-channel predictively. This is based on the finding that dependencies between a temporal block and one or more portions of the signal of the predetermined coded channel can be found, so that a prediction signal with high accuracy can be obtained increasing a compression efficiency.

Accordingly, in accordance with a first aspect of the present application, a decoder/encoder for decoding/encoding a multi-channel digital signal from/into a data stream is configured to decode/encode coded channels representing the multi-channel digital signal from/into the data stream in temporal blocks by predicting a current temporal block of a predetermined coded channel from one or more (e.g., previously decoded/encoded) reference block portions of the predetermined coded channel.

An embodiment is related to a method for decoding/encoding a multi-channel digital signal from/into a data stream comprising decoding/encoding coded channels representing the multi-channel digital signal from/into the data stream in temporal blocks by predicting a current temporal block of a predetermined coded channel from one or more (e.g. previously decoded) reference block portions of the predetermined coded channel.

The method as described above is based on the same considerations as the above-described decoder/encoder. The method can, by the way, be completed with all features and functionalities, which are also described herein with regard to the decoder/encoder.

In accordance with a second aspect of the present invention, the inventors of the present application realized that even though a digital time-varying signal might be highly oscillatory, which means that it fully exploits the allowed sample-value range within very short time intervals, it is advantageous to predict a current temporal block of the digital time-varying signal from one or more reference block portions of the digital time-varying signal. This is based on the finding that dependencies between a temporal block and one or more portions of the digital time-varying signal can be found, so that a prediction signal with high accuracy can be obtained increasing a compression efficiency. The signal's properties (e.g., amplitude, frequency, phase) may often change over time, so that a suitable reference block may not directly precede the temporal block, which is to be predicted. Therefore, it is proposed to signal in a data stream a position of the reference block portion or positions of the two or more reference block portions within the digital time-varying signal. This is based on the idea that this approach allows to capture these variations accurately and allows to efficiently encode highly dynamic signals and signals with irregular features.

Accordingly, in accordance with a second aspect of the present application, a decoder/encoder for decoding/encoding a digital time-varying signal from/into a data stream is configured to decode/encode the digital time-varying signal from/into the data stream in temporal blocks by decoding/encoding a current temporal block of the digital time-varying signal by decoding/encoding, from/into the data stream, for each of one or more reference block portions of the digital time-varying signal, a (e.g., starting) position of the respective reference block portion in the digital time-varying signal, and predicting the current temporal block of the digital time-varying signal from the one or more (e.g., previously decoded/encoded) reference block portions of the digital time-varying signal.

An embodiment is related to a method for decoding/encoding a digital time-varying signal from/into a data stream comprising decoding/encoding the digital time-varying signal from/into the data stream in temporal blocks by decoding/encoding a current temporal block of the digital time-varying signal by decoding/encoding, from/into the data stream, for each of one or more reference block portions of the digital time-varying signal, a (e.g., starting) position of the respective reference block portion in the digital time-varying signal, and predicting the current temporal block of the digital time-varying signal from the one or more (e.g., previously decoded/encoded) reference block portions of the digital time-varying signal.

The method as described above is based on the same considerations as the above-described decoder/encoder. The method can, by the way, be completed with all features and functionalities, which are also described herein with regard to the decoder/encoder.

An embodiment is related to a data stream having a multi-channel digital signal or a digital time-varying signal encoded thereinto using a herein described encoder or method for encoding.

An embodiment is related to a computer program having a program code for performing, when running on a computer, a herein described method, when being executed on the computer.

### BRIEF DESCRIPTION OF THE DRAWINGS

The drawings are not necessarily to scale, emphasis instead generally being placed upon illustrating the principles of the invention. Embodiments of the present invention will be detailed subsequently referring to the appended drawings, in which:

FIG. 1 shows an encoder for encoding a multi-channel digital signal into a data stream as well as decoder for decoding the multi-channel digital signal from the data stream;

FIG. 2A shows a decoder for decoding a multi-channel digital signal using an inter-channel prediction mode; and

FIG. 2B shows a decoder for decoding a multi-channel digital signal using an intra-channel prediction mode.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

### 1 Embodiments

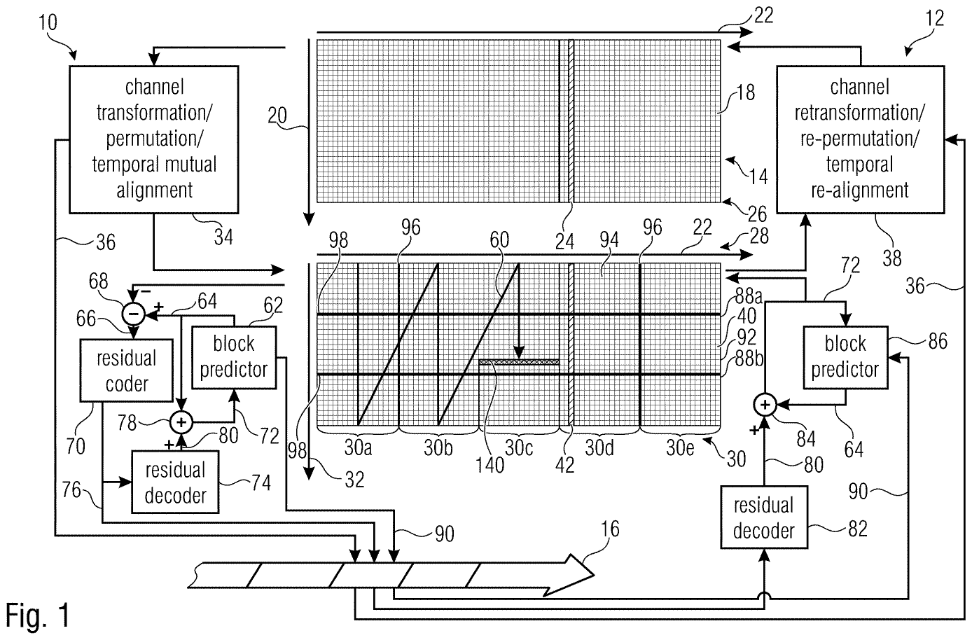

In the following description a presentation of embodiments is provided. Before this, however, the description proceeds with a presentation of a possible framework or codec into which the embodiments described further below may be built into. Many details described in this framework are, however, optional when being combined with any of the subsequently described embodiments. To be more precise, the framework is described with respect to FIG. 1 which shows an encoder for encoding a multi-channel digital signal 14 into a data stream 16 as well as a decoder 12 for decoding the multi-channel digital signal 14 from the data stream 16. This description of FIG. 1 shall be seen as a presentation of new embodiments of the present application which result when combining any of the embodiments described subsequently with the decoder 12 or encoder 10 of FIG. 1 either by adopting all details/functionalities described with respect to FIG. 1 or with leaving-out some of the details/functionalities described with respect to FIG. 1. Sometimes such “optional” features of FIG. 1 are explicitly identified as being optional with respect to the combination of the subsequently described embodiments, but the just-mentioned possible combinations of the subsequently explained embodiments with the description of FIG. 1 shall not be restricted to these explicitly identified variations of FIG. 1 in terms of leaving-out certain features.

In FIG. 1, the multi-channel digital signal 14 is illustrated by way of an array of samples with the samples being illustrated as small squares 18. Each line/row corresponds to a certain channel of the multi-channel digital signal 14. Each channel of signal 14 may have associated therewith a respective channel ID and FIG. 1 shows these channels as being ordered according to their channel ID along vertical axis 20 which, thus, corresponds to a “source” channel axis 20. The horizontal axis 22 corresponds to time so that samples 18 forming one column, or being horizontally aligned, are samples belonging to one common time instant. Such set/column of temporally co-located samples 18 is illustrated in FIG. 1 at 24.

Each channel, thus, forms a digital time-varying signal or time/amplitude or time-to-amplitude signal. The multi-channel digital signal m might have been obtained by at least one of Electrocardiography, Electroencephalography, Electromyography or seismic measurement. Differently speaking, the multi-channel digital signal might be a bio-physiological waveform data such as an electroencephalography (EEG) signal, an electrocardiogram (ECG), or an electromyography (EMG) signal, or seismic waveform data. However, each channel/signal might alternatively be another sort of waveform signal data such as scalar media data such as an audio signal and the signal 14 might be a multi-channel audio signal.

FIG. 1 illustrates the option according to which signal 14 is not coded directly, i.e., in the original domain 26, but in a so-called “coded domain” 28 which might differ from the original domain 26 by one or more of 1) channel transformation, 2) channel permutation and 3) temporal mutual channel alignment. The channel transformation, if applied, transforms, per sample time instant, a set or column 24 of samples from domain 26 to domain 28. Thus, in domain 28, the sample pitch and the time axis is the same as in domain 26, but the meaning of the channels is different, i.e., the “source” channels of domain 26 become transformed channels in domain 28. Accordingly, the vertical axis in FIG. 1 for domain 28 is denoted as 32. Note that the channel transformation might leave the number of channels unchanged so that there is the same number of channels in domain 26 as well as domain 28, but different approaches are also possible. Generally, the channel transformation would aim at reducing redundancy and trying to condense the channels' energy onto a fewer number of channels in domain 28. As said, the channel transformation is optional. Accordingly, in general terms, the channels in domain 28 are called “coded channels” in order to distinguish them from the “original” or “source” channels of digital signal 14 in domain 26. The permutation is also optional and may be used in combination with, or without, the channel transformation. If used in combination with the channel transformation, the permutation may be performed prior to and/or or subsequent to the channel transformation in order to permute/sort the source channels prior to transformation and the coded channels subsequent to the channel transformation. The channel transformation might be a DCT, DST, FFT or any other transformation. The temporal mutual alignment is also optional and might be seen as a constant temporal alignment between the source channels or the coded channels.

The module in encoder 10 performing the one or more of channel transformation, channel permutation and temporal mutual alignment is indicated in FIG. 1 as block 34. Side information 36 might be used in order to signal information on one or more of the following: 1) The channel transformation used, 2) information on the permutation(s) among the source channels and/or coded channels and 3) information on the mutual temporal alignment/delays between the source channels or coded channels wherein the temporal mutual alignment might be restricted to full sample precision. A corresponding block 38 in decoder 12 performs the reverse step, i.e., performs one or more of: 1) a channel retransformation, 2) a re-permutation of the source channels and/or coded channels and 3) a temporal re-alignment of the source channels or coded channels. Note, that if no channel transformation takes place, the coded channels are, in fact, equal to the source channels except for being temporally mutually aligned or being differently sorted due to permutation. Block 38 might be controlled by the before-mentioned side information 36.

Thus, the “actual coding” relates to the coded channels in domain 28. In the coded domain 28, the coded channels are depicted in FIG. 1 as lines or rows of samples 40, each extending along time axis 22, the coded channels being depicted one on top of the other along coded channel axis 32-potentially ordered according to a coded channel ID they have associated therewith-so as to result into an array of samples 40. Again, although FIG. 1 depicts the case that the number of source channels equals the number of coded channels, the number might be different. Further, if channel transformation is used, while there is no longer a clear association between source channels on the one hand and coded channels on the other hand, the temporal association remains: For each temporally co-located samples 24, there is a corresponding temporally co-located set 42 of samples 40 of the coded channels, wherein the set 42 in domain 28 is a column and might be a set of horizontally mutually offset samples in case of, and according to, the mutual temporal alignment, if applied. In case of FIG. 1, it has been assumed that no such temporal alignment took place so that both sets 42 and 24 are pure columns in the time/channel representation.

The actual coding is done in units of so-called temporal blocks 30. The term “temporal block” 30 is used so as to denote both a temporal portion of the multi-channel signal in domain 28, i.e., the set of coded channels, as well as a temporal portion of a certain coded channel. That is, for each temporal block 30, each coded channel has a temporal block such as block 140 depicted for some temporal block 30c and same are mutually co-located. The coding is done sequentially along these blocks 140, by following a coding/decoding order, which traverses the blocks 140 temporal block 30 by temporal block 30 with traversing temporally co-located blocks of the coded channels along a channel order corresponding to the order of the coded channels along axis 32. This coding/decoding order is illustrated in FIG. 1 at 60. That is, in case of temporal block 140 being the block currently to be coded/decoded, the previously decoded/encoded temporal blocks include all preceding temporal blocks of all coded channels as well as the temporally co-located temporal blocks of coded channels preceding the coded channel 92 of temporal block 140 in channel order. These previously coded/decoded temporal blocks and their samples are illustrated in FIG. 1 by way of shading. In this regard, note that in FIG. 1, merely one temporal block 140 has been illustrated explicitly in order to reduce the complexity of FIG. 1. Thus, in the specification herein, reference sign 140 is sometimes used to indicate the currently encoded/decoded temporal block or to stand representatively for all temporal blocks. Further, as depicted in FIG. 1, the partitioning of signal 14 into temporal blocks 30 and 140, respectively, might be done in a manner so that these blocks 30 and 140, respectively, are non-overlapping.

In other words, the decoder 12/encoder 10 may be configured to decode/encode the coded channels from/into the data stream 16 in the temporal blocks 30 by sequentially (e.g. using a channel order which, in the above description, follows the channel index to which axis 32 relates) decoding/encoding from/into the data stream 16 a predetermined temporal block of each of the coded channels before decoding/encoding a subsequent temporal block of any of the coded channels (e.g. the segments being indicated by curly brackets 30). The temporal blocks 30, for example, are temporally aligned among the coded channels (e.g. so that the decoding order 60 traverses the temporal blocks 30 across all coded channels within a certain temporal block first before proceeding with the subsequent temporal block; note that the “reference block portions” are temporal/blockal portions of the same length as the “temporal blocks” in units of which the decoding is performed), so that mutually co-located temporal blocks of the coded channels commonly start at a predetermined time instant and end at a further predetermined time instant at which the subsequent temporal segment of the coded channels start.

The actual coding in units of the temporal blocks 140 is performed predictively. That is, the encoder 10 comprises a block predictor 62 which predicts the samples of the currently coded temporal block 140, thereby yielding a prediction signal 64, and the prediction residual 66 formed by a subtraction between the actual sample values of temporal block 140 and the predicted samples of prediction signal 64 formed at a subtractor 68 is coded into the data stream 16 by residual coder 70. The residual coding in residual coder 70 may, or may not, involve a coding error by means of quantization. In any case, block predictor 62 uses the reconstructable version as being available by previously coded temporal blocks in order to obtain the prediction signal 64. This reconstructable version 72 might be derived at encoder 10 by means of a residual decoder 74 which reverses potential coding loss, such as quantization by means of dequantization, manifesting itself in the residual signal 76 coded into data stream 16, and an adder 78 which sums-up prediction signal 64 and the reconstructable residual signal 80 as obtained by residual decoder 74.

The decoder 12 decodes the coded channels from data stream 16 in a corresponding manner, i.e., in units of the temporal blocks 30 or in temporal blocks 140, respectively, and using predictive decoding. To this end, the decoder 12 comprises a residual decoder 82, an adder 84 and a block predictor 86 which correspond to, and are mutually connected in the same manner as, elements 74, 78 and 62 of encoder 10. That is, the residual decoder 82 derives from the residual signal 76 in data stream 16 the reconstructable residual signal 80 for a currently decoded temporal block 140 which is then subject to addition with prediction signal 64 derived by block predictor 86 for temporal block 140 on the basis of the reconstructed version 72 of previously decoded temporal blocks at adder 84. The output of adder 84, thus, yields the reconstructed version 72 of the currently decoded temporal block 140 and becomes part of the pool of already decoded samples of previously decoded temporal blocks when the temporal blocks of the coded channels are, in this manner, traversed along coding/decoding order 60 so as to reconstruct the coded channels in the coded domain 28.

In order to enable a high degree of random access capability, some of the temporal blocks may be coded in a random access manner meaning that the coded channels therein are coded independent from previous temporal blocks 30. Imagine, for instance, that temporal blocks 30b and 30e are random access temporal blocks. Then, none of the temporal channel blocks 140 in temporal block 30b as well as 30e would depend on any preceding temporal block 140 such as none temporal block within temporal block 30a forming a coding dependency basis for any temporal channel block 140 in temporal block 30b and none of the temporal channel blocks 140 within temporal blocks 30a to 30d forming a coding dependency basis for any of the temporal channel blocks 140 within temporal block 30e. Thus, in other words, coding dependencies are restricted so as to not reach-out beyond the border 96 of a random access temporal block 30b and 30e towards any preceding temporal block 30. Such restriction might also hold for intermediate temporal blocks 30c to 30d between random access temporal blocks 30b and 30e in that same may not depend on any temporal block preceding the leading one among the random access temporal blocks 30b and 30e, here block 30b. Accordingly, leading temporal borders 96 of the random access temporal blocks 30b and 30e are indicated by bold lines in FIG. 1.

Further, it might be that the coding of the coded channels also interrupts or restricts inter-channel dependencies by coding one or more of the coded channels as random access coded channels so that coding dependencies of these random access coded channels, or even these random access coded channels and the intermediate coded channels there between, are restricted so as to not reach-out beyond such a random access coded channel toward any coded channel preceding that random access coded channel in channel order along axis 32. Two such random access coded channels 88a and 88b and their associated inter-channel dependency borders 98 are illustrated in FIG. 1.

The block predictor 62 and 86 of encoder 10 and decoder 12, respectively, operate synchronously, i.e., they generate the same prediction signal 64 based on the previously encoded/decoded samples of previously encoded/decoded temporal blocks 140. On encoder side 10, the prediction for a certain temporal block 140 may be accompanied or determined by one or more prediction parameters. Same might be determined on encoder side based on a rate/distortion optimization. These prediction parameters 90 are coded into data stream 16 and they are decoded from data stream 16 and used by block predictor 86 so as to perform the same prediction.

It might be that encoder 10 and decoder 12 support more than one prediction mode. For instance, encoder 10 and decoder 12 may support an intra prediction mode (which mode may also be called block-copy mode) according to which the currently encoded/decoded temporal block 140 is predicted based on the reconstructed/reconstructable sample values of previously encoded/decoded temporal blocks of the same coded channel to which the currently encoded/decoded temporal block 140 belongs, which is coded channel 92 in the example of FIG. 1. Additionally or alternatively, encoder 10 and decoder 12 may support an inter-prediction mode (which mode may also be called cross-channel prediction mode) according to which the currently encoded/decoded temporal block 140 is predicted based on the reconstructed/reconstructable sample values of previously encoded/decoded temporal blocks of coded channels preceding—in coding order 32—the coded channel 92 to which the currently encoded/decoded temporal block 140 belongs.

Additionally or alternatively, there may be a mixed prediction mode according to which the prediction signal 64 is obtained by both, reconstructed/reconstructable sample values of previously encoded/decoded temporal blocks of coded channel 92 itself as well as reconstructed/reconstructable sample values of coded channels preceding coded channel 92 in channel order along axis 32. Beyond this, there may be temporal blocks 140 which are coded without any prediction at encoder 10 and decoded without any prediction at decoder 12 such as the first temporal blocks in the tiles 94 resulting from mutually separating the temporal blocks by means of the random access borders 96 on the one hand and the random access channel borders 98 on the other hand. This corresponds to the prediction signal 64 being set to zero and this may form an additional mode which could be called bypass mode. Additionally, or alternatively, there may be other modes such as ones deriving a DC predictor or linear function predictor for block 140 based on immediately preceding samples of block 140. The prediction parameters 90 may, thus, contain for a currently encoded/decoded temporal block 140 a prediction mode flag or prediction mode indicator indicating the prediction mode to be used for this currently encoded/decoded temporal block 140 and, optionally, one or more parameters parameterizing the prediction mode to be used for this currently encoded/decoded temporal block 140.

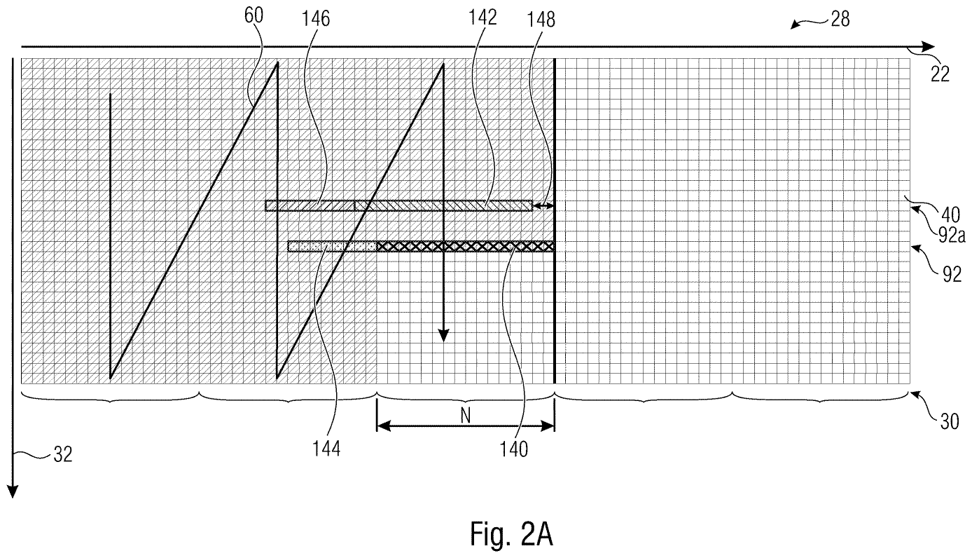

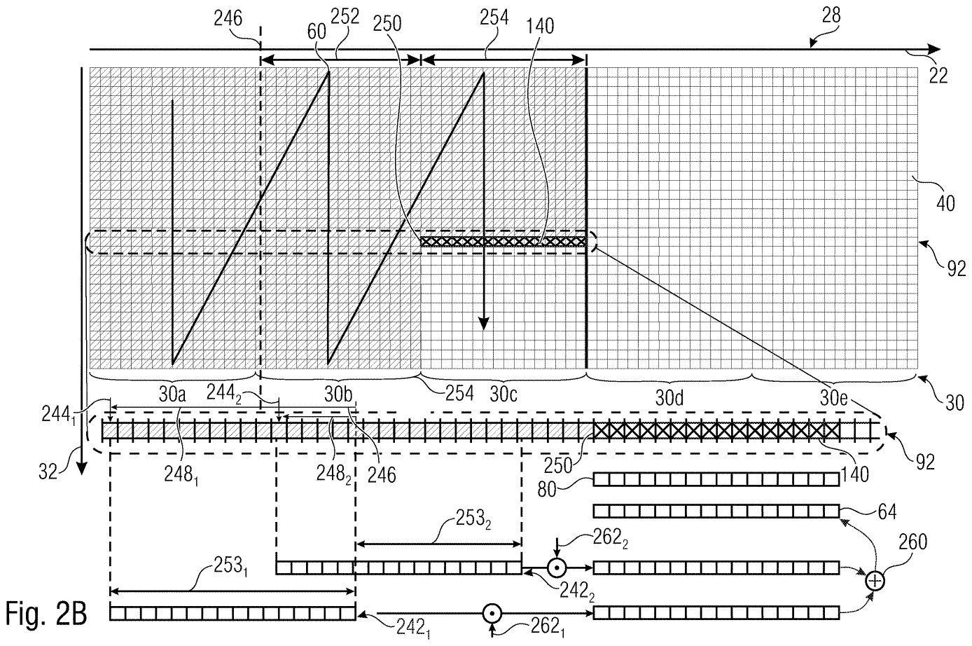

For example, the encoder 10 and the decoder 12 may support different segment coding modes, e.g., block coding modes, including an inter prediction coding mode and an intra prediction coding mode, wherein a mode indicator may indicate whether a current temporal block 140 is to be coded using inter prediction or intra prediction. According to an embodiment, if the mode indicator is indicative of the inter prediction mode, the decoder 12/encoder 10 is configured to (see FIG. 2A) determine one or more prediction parameters for predicting the current temporal block 140 of the predetermined coded channel 92 based on a reference block portion 142 of a set of one or more reference channels 92a (e.g. preceding the predetermined channel 92 in channel (coding) order 32) of the coded channels based on a preceding (e.g. previously decoded/encoded; one temporally preceding the current temporal block 140) temporal block 144 of the predetermined coded channel 92 and a preceding (e.g. previously decoded/encoded; one temporally preceding the reference block portion 142) temporal reference block 146 of the one or more reference channels 92a, and configured to predict the current temporal block 140 of the predetermined coded channel 92 from the reference block portion 142 of the one or more reference channels 92a using the one or more prediction parameters. According to an embodiment, if the mode indicator is indicative of the intra prediction mode, the decoder 12/encoder 10 is configured to predict the current temporal block 140 of the predetermined coded channel 92 from the one or more reference block portions 242 of the predetermined coded channel 92 (see FIG. 2b). Alternatively, if the mode indicator is indicative of the intra prediction mode, the decoder 12/encoder 10 is configured to decode/encode, from/into the data stream 16, for each of one or more reference block portions 242 of a digital time-varying signal (e.g., being a predetermined coded channel 92 of coded channels representing the multi-channel digital signal 14), a position 244 of the respective reference block portion 242 in the digital time-varying signal, and configured to predict the current temporal block 140 of the digital time-varying signal from the one or more (e.g. previously decoded/encoded) reference block portions 242 of the digital time-varying signal.

According to an embodiment, if the current temporal block 140 forms a random access point of the data stream 16, the decoder 12/encoder 10 is configured to skip the decoding/encoding the mode indicator and infer that the mode indicator does not indicate the intra prediction mode.

The aforementioned coding dependencies ought not to cross any of the borders 96 and 98 not only result from the just-described sample prediction capabilities of block predictor 62 and 86, respectively, but may optionally also result from other mechanisms such as parameter prediction according to which parameters such as the aforementioned prediction parameters 90 for a certain temporal block 140 are predicted based on coding parameters conveyed in the data stream 16 for any previous temporal block, or context derivation for context-adaptive entropy coding/decoding any coding parameter such as the prediction parameters 90 or any other side information such as side information 76 and 36 for temporal block 140 based on any coding parameter conveyed in the data stream 16 for any preceding temporal block.

That is, summarizing, the encoder 10 encodes the multi-channel signal 14 by transferring it into the coded domain 28 and then coding the coded channels into data stream 16 in the just-described block-wise and predictive manner, wherein decoder 12 decodes the coded channels of coded domain 28 from data stream 16 and the corresponding block-wise and predictive manner with then gaining the multi-channel signal 14 in its original form 26 based on the coded channels in coded domain 28 by means of segment 38. As said, the channel transformation is optional and if not used, each sample 40 in the coded domain 28 really corresponds to one sample 18 in the original domain 26. If, further, the temporal mutual alignment is not used, each sample 40 exactly corresponds to a sample 18 in the original domain 26 at exactly the same time instant or, differently speaking, all temporally co-located samples 40 in coded domain 28 remain mutually temporally co-located in the original domain 26.

As mentioned before, FIG. 1 only represents a possible “framework” into which the embodiments described subsequently may be built into. Many modifications may be performed with respect to FIG. 1, and some of these modifications might be mentioned in the subsequent description with respect to certain ones of the subsequently described embodiments, but these modifications shall then be treated as being also applicable with respect to other ones of the subsequently described embodiments. Further, as a final note, and without being treated as forming an exclusive list of further possible amendments of the description of FIG. 1, it shall be noted that the temporal blocks 30 might, other than illustrated in FIG. 1, vary in block length rather than being of a constant length as depicted in FIG. 1. For instance, encoder 10 may decide on the length of blocks 30 and signal a length parameter or the block length of blocks 30 (and the corresponding temporal blocks 140 of the coded channels) within data stream 16 and the decoder may be configured to set the length of blocks 30 based on the information provided by the data stream 16. According to an embodiment, the decoder 12/encoder 10 is configured to switch between the different lengths of the temporal blocks at predetermined borders between consecutive temporal blocks according to the length parameter. Further, although not described before, it might be that residual coder and residual decoder 70 and 82 may use transform coding/decoding in order to convey the residual signal 76 in data stream 16. That is, the residual signal 80 may be conveyed in data stream 16 in transform domain by way of transform coefficients in residual signal 76. The transform domain might be a DCT, DST or an FFT. The transform may be non-overlapping, i.e. it may only transform residual signal 80 and its re-transform may only cover residual signal 76 within block 140, and/or may be non-windowed, i.e. the residual signal might be transformed without any transform window used to temporally shape the residual signal 80 before the transform. The transform domain, i.e. the transformation leading from time domain to transform domain which is used by the encoder to transform the prediction residual signal 80 to be coded und the corresponding re-transformation leading from transform domain to time domain which is used by the decoder to derive the prediction residual signal 80, or the transformation, might be selected from a set of available transforms including, for instance, one or more of 1) one or more DCTs, 2) one or more DSTs and 3) an identity transform according to which the prediction residual signal 80 is coded into the data stream 14 in time domain directly. Some deblocking processing might be used to avoid blocking artifacts. If, alternatively, an overlapped transform is used, an overlap-add processing with re-transforms of immediately preceding/succeeding temporal blocks of the same coded channel might be used in order to completely reconstruct the current temporal block's 140 residual signal 76. Besides such transform-(residual)-coded blocks there might be temporal blocks 140 which, additionally or alternatively, are coded using, besides the block prediction by block predictor 62/86—which could be called a primary prediction—a secondary sample-wise prediction of the residual samples in residual block 66 such as by predicting a current sample's residual sample by means of already decoded values of preceding—in sample coding order—residual samples in block 66 or 80, with then correcting same by means of a secondary-prediction-residual sample decoded from the data stream 16. The secondary-prediction-residual samples for such a block may coded into the data stream en block in a transform domain or sample-wise in time domain.

The description is now resumed with respect to the announced subsequently described embodiments, here namely embodiments relating to inter-channel prediction. As described with respect to FIG. 1, the embodiments with respect to decoder and encoder described in the following may relate to such decoders and encoders which comprise the inter-channel prediction as one mode among one or more others, but the inter-channel prediction mode may alternatively be the only available prediction mode. That is, generally, FIG. 2A relates to a decoder for decoding a multi-channel digital signal 14 from a data stream 16, which is configured to decode coded channels representing the multi-channel digital signal 14, namely those in domain 28, from the data stream 16 in temporal blocks 140, namely temporal coded channel blocks, with sequentially decoding from the data stream 16 a predetermined temporal block 140 of each of the coded channels before decoding a subsequent temporal block of any of the coded channels, and to an encoder for encoding a multi-channel digital signal 14 into a data stream 16, which is configured to encode coded channels representing the multi-channel digital signal 14, namely those in domain 28, into the data stream 16 in temporal blocks 140, namely temporal coded channel blocks, with sequentially decoding from the data stream 16 a predetermined temporal block 140 of each of the coded channels before decoding a subsequent temporal block of any of the coded channels.

In order to describe the inter-channel prediction mode, reference is made to FIG. 2A. In encoding/decoding a currently encoded/decoded temporal block 140, one or more prediction parameters for predicting the current temporal block 140 are determined first. The one or more prediction parameters are for, or control, the prediction of the current temporal block 140 of a predetermined coded channel 92 based on a reference block portion 142 of a set of one or more reference channels 92a. In FIG. 2A, merely one such reference channel 92a is illustrated to be used for the prediction of temporal block 140 for illustration purposes and ease of explanation, but the number may be larger than one. As became clear from the description above, reference channels such as reference channel 92a need to precede the predetermined coded channel 92 in channel coding order 32 and might have, for instance, a lower channel index associated therewith than compared to predetermined coded channel 92 comprising the currently encoded/decoded temporal block 140. A further note shall be made with respect to the term “reference block portion”. Reference block portions such as reference block portion 142 are portions of immediately consecutive samples 40 of the reference channel 92a, with a number of comprised immediately consecutive samples 40 being equal to the number of samples within temporal block 140, but they are not necessarily restricted to be registered or to be temporally located to temporal block 140 or to any other temporal block 30, i.e. they might be placed freely expect for the fact that reference block portions need to comprise or cover previously decoded/encoded samples only, and except for an optional maximum temporal distance to block 140. That is, the reference block portions such as reference block portion 142 might be temporally shifted relative to temporal block 140 as described in more detail below.

The one or more prediction parameters determined for temporal block 140 are for defining as to how, computationally, the prediction signal 64 for predicting temporal block 140 is derived from the reference block portion(s) 142 or to be more precise, the reconstructed/reconstructable samples in reference block portion(s) 142. As will be described in more detail below, the one or more prediction parameters may, for instance, define scale and offset such as a scale for each reference block portion 142 by means of which the reference block portion 142 is scaled (by multiplying it or, to be more precise, its reconstructed/reconstructable samples, by multiplication with the scale), with then adding the offset to the scaled reference block portion or, in case of more than one reference block portion 142, forming a sum over all scaled reference block portions and the offset.

The determination of the one or more prediction parameters is done based on temporal segments 144 and 146 of channels 92 and 92a, each consisting of immediately consecutive samples 40 of the respective channel, and each of which temporally preceding the corresponding block, i.e. block 140 in coded channel 92, and reference block portion 142 in channel 92a, respectively. For instance, segments 144 and 146 might be defined to be located immediately preceding the corresponding block 140 and 142, respectively, as illustrated in FIG. 2A, but it might alternatively be that the temporal positioning of segments 144 and 146 is defined in a different manner such as in a manner so that the segments 144 and 146 are mutually temporally co-located such that, for instance, all segments 144 and 146 contain the samples 40 immediately preceding, temporally, the block among block 140 and block 142 which is the earliest in time. As can be seen in FIG. 2A, segments 144 and 146 mutually coincide in the number of samples 40 contained therein, wherein this number L may be equal to or different from the number N of samples in blocks 140 and 142, respectively. For instance, L might be chosen to be smaller than N as illustrated in FIG. 2A.

The advantage of determining the one or more prediction parameters using which temporal block 140 is predicted from the reference block portion 142 of the one or more reference channels 92a based on an evaluation of the temporal segments 144 and 146, is the fact that this determination may be done by both encoder 10 and decoder 12 because the temporal segments 144 and 146 are both comprised by the reservoir or pool of already encoded/decoded samples so that the determination of the one or more prediction parameters may be done inherently without any explicit signaling in data stream 16, thereby reducing the side information signaling overhead.

The determination itself is done in the following manner: in particular, it is a pretty good assumption that a relationship of the currently encoded/decoded temporal block 140 to the reference block portion 142 of the one or more reference channels 92a is the same as, or is at least pretty close to, the relationship of temporal segment 144 of coded channel 92 relative to the temporal reference segment 146 in each reference channel 92a. Thus, if the one or more prediction parameters are determined so that their application onto the temporal reference segment 146 of the one or more reference channels 92a results into a “prediction” for temporal segment 144 which minimizes the prediction residual towards the temporal segment 144, this one or more prediction parameter should, if the assumption holds true, also minimize the deviation of the prediction signal 64 obtained by applying the one or more prediction parameters thus determined onto the reference block portion 142 of the one or more reference channels 92a from the block 140 to be coded/decoded. As a result, the prediction residual 80 coded into data stream 16 may be coded with fewer bits due to the preciseness in having derived prediction signal 64.

If the one or more prediction parameters consist of a scale for the, in case of only one reference block portion, reference block portion 142 or for each reference block portion 142 in case of having more than one reference block portion, and an offset, as just-described, then the determination of this scale and offset may be performed as follows with here assuming that x₁, . . . , x_{N} denote the reconstructed/reconstructable samples in segment 144, while y_{i,j} denotes the j^{th} sample in segment 146 of the i^{th} reference block portion with i ∈ {1, . . . , K}, and j ∈ {1, . . . , L} and λᵢ denoting the scale for the i^{th} reference block portion and b denoting the offset. Then, the minimization of the deviation when applying the prediction parameters onto y_{i,j} from samples xⱼ in terms of sum of squares, i.e.

$${\sum }_{j = 1}^{L} {( {x}_{j} - {\sum }_{i = 1}^{K} ( {λ}_{i} \cdot {y}_{i , j} - b ) )}^{2} \to min$$

is achieved by the solution of the following equation and, thus, decoder and encoder solve this linear equation and in doing so, decoder and encoder may use a lookup table in order to avoid the computation of the scale and offset involving a division. The equation is:

$$M \cdot ( \begin{matrix}{λ}_{1} \\ ⋮ \\ {λ}_{K} \\ 1\end{matrix} ) = ω$$

$$with$$

$$M = {( {M}_{k , l} )}_{k , l = 1}^{K + 1} ∈ {ℝ}^{( K + 1 ) \times ( K + 1 )}$$

$${M}_{k , l} = \{ \begin{matrix}{\sum }_{j = 1}^{L} ( {y}_{k , j} \cdot {y}_{l , j} ) , if k , l \leq K \\ {\sum }_{j = 1}^{L} {y}_{k , j} , if l = K + 1 and k \leq K \\ {\sum }_{j = 1}^{L} {y}_{l , j} , if k = K + 1 and l \leq K \\ L , if k = l = K + 1\end{matrix}$$

$$ω = ( {ω}_{1} , … , {ω}_{K + 1} ) ∈ {ℝ}^{K + 1}$$

$${ω}_{i} = \{ \begin{matrix}{\sum }_{j = 1}^{L} {x}_{j} \cdot {y}_{i , j} , if i \leq K \\ {\sum }_{j = 1}^{L} {x}_{j} , if i = K + 1\end{matrix}$$

Thus, as described, the inter-prediction according to FIG. 2A may involve one or more reference block portions 142 and the computation of the one or more prediction parameters may be performed in a manner avoiding a division which is approximated by way of a table lookup instead.

It is further noted that, in case of more than one reference block portion 142 being used for the currently encoded/decoded temporal block 140, each one of same is, according to an embodiment, contained in a separate one of the reference channels. That is, each reference channel would have exactly one reference block portion. However, as an alternative, it might be that the reference block portions partially, or all of same, belong to a common reference channel such as reference channel 92a.

As already mentioned above, the reference block portion(s) 142 might be located temporally offset relative to temporal block 140. For instance, data stream 16 may have, for each of a set of one or more inter-channel predicted channels out of the coded channels, for each of the one or more reference channels, a temporal offset 148 encoded thereinto at which 1) the reference block portion 142 of the respective reference channel 92a is temporally offset, such as delayed as depicted in FIG. 2A, relative to the current temporal block 140 of the predetermined coded channel, and 2) the preceding temporal reference block portion 146 of the respective reference channel 92a is temporally offset, such as delayed as depicted in FIG. 2A, relative to the preceding temporal block portion 144 of the predetermined coded channel 92. The decoder 12 decodes the temporal offset 48 from the data stream 16 accordingly. The granularity at which this temporal offset 48 is coded in the data stream 16 may be designed in one of the following options: for instance, the temporal offset 48 for each reference channel for a certain inter-channel predicted coded channel might be coded into data stream 16 at a scope valid for the whole data stream, or may be coded for each sequence of temporal blocks 30 from a random access temporal block such as 30b until the temporal block 30d immediately preceding the next random access temporal block 30e, or may be conveyed in data stream 16 temporal block individually, i.e. for each inter-predicted temporal block such as segment 140, individually. The set of one or more inter-channel predicted coded channels may include all channels except for the random access coded channels 88a and 88b (wherein in FIG. 1 the coded channel corresponding to the uppermost sample line might also be a random access coded channel, as it might be the first channel in channel order 32). The number of reference channels might also be coded in the data stream 16 in any of the just-mentioned granularities and even at a granularity which differs from the granularity at which the temporal offset signaling is done. The number of reference channels might be chosen to be equal for all inter-channel predicted coded channels, or might be signaled in the data stream 16 in a manner so that the number of reference channels differs among the inter-channel predicted channels. In case of allowing two reference block portions to belong to the same reference channel, for each reference channel, it might additionally be signaled as to how many reference block portions are contained in the respective reference channel for a certain inter-channel predicted coded channel. In any case, the decoder uses the temporal offset 48 coded in the data stream in order to cut-out out of the respective reference channel, or derive, the reference block portion 142 and the preceding temporal reference block portion 146 from the respective reference channel 92a using the temporal offset 148 signaled for the respective reference channel. Further, the data stream 16 may have, for each of the set of one or more reference channels, a channel index coded thereinto, which identifies the respective reference channels out of the coded channels which precede the coded channel 92 in channel order 32. Alternatively, the set of one more reference channels of a certain inter-channel predicted coded channel might, by default, include all those coded channels preceding in channel order 32, which immediately precede the current channels 92 in channel order. As described before, for each inter-channel predicted coded channel, the number of coded channels which may form one of the set of one or more reference channels, is restricted as same are merely allowed to be recruited from the coded channels preceding the respective inter-channel predicted coded channel up to the nearest preceding random access channel such as channel 88a in case of channel 92 in FIG. 1. Accordingly, a channel index conveyed in the data stream 16 may be coded into data stream 16, and may be decoded therefrom, using a parametrized binarization, such as a truncated unary code, parametrized using a binarization parameter, such as the truncation parameter, which might be set by encoder and decoder in such a manner so that the number of binary strings formed by the parametrized binarization becomes closest to—with becoming equal or greater than—this number of coded channels preceding the respective inter-channel predicted coded channel in channel order 32 up to the nearest—in channel order—preceding random access channel. With respect to the temporal offset 148 and the derivation of the temporal reference block portion 46 and the reference block portion 142 from the reference channel 92a, the following is noted. In particular, according to an embodiment, the temporal offset 148 is restricted to full-sample offsets, meaning that the temporal reference block portion 146 as well as the reference block portion are respectively formed by consecutive samples 40 of the corresponding reference channel, the consecutive samples being shifted relative to the samples of block portion 144 and segment 140, respectively, by a number of samples indicated by offset 148. The derivation of reference block portion 146 and reference block portion 142 is, thus, merely a cutting-out of the corresponding samples out of the samples of reference channel 92a. However, alternatively, the temporal offset 148 may also allow for sub-sample offsets so that the derivation might include a sub-sampling of the reference channel to result into reference block portion 146 and reference block portion 142, respectively.

A further note shall be made with respect to the freedom for encoder 10 to choose the temporal offset 148, the number of reference channels and the selection of the number of reference channels out of the available preceding coded channels for a certain coded channel 92, or for a subset of these settings. For instance, the encoder 10 may determine these parameters or settings as optimization variables in a rate/distortion optimization scheme, or may select same in a different manner such as by inspecting certain similarity measures or the like.

In the following, the announced subsequent embodiments dealing with intra prediction are presented. As outlined above, these details describe an encoder and a decoder for encoding/decoding a multi-channel digital signal 14, wherein these embodiments may be combined with a teaching of a possible framework presented above with respect to FIG. 1, both with adopting all details presented with respect to FIG. 1 as well as combining subsequent embodiments merely with a subset of these details. Generally, FIG. 2B presents embodiments for a decoder configured to decode coded channels representing a multi-channel digital signal 14 from the data stream 16 in temporal blocks 140, and an encoder configured to encoder coded channels representing a multi-channel digital signal 14 into the data stream 16 in temporal blocks 140.

Each channel of the multi-channel digital signal 14 may represent a digital time-varying signal. Therefore, the following description of intra-channel prediction may also represent a description of a prediction for decoding/encoding of a digital time-varying signal. Since the intra-channel prediction can be done channel individually, the following description may not only apply to decoding/encoding a digital time-varying signal of a multi-channel digital signal 14 (e.g., the digital time-varying signal is a predetermined coded channel 92 of coded channels representing the multi-channel digital signal 14), but also to the decoding/encoding of a digital time-varying signal, which may be available individually (e.g., not together with further digital time-varying signals in a multi-channel digital signal 14).

According to FIG. 2B, a current temporal block 140 of a predetermined coded channel 92 is predicted from one or more reference block portions 242, e.g., see 242₁ and 242₂, of the same channel, i.e. the predetermined coded channel 92. The “reference block portions” 242 equal the currently encoded/decoded temporal block 140 in the number of samples, but same are not restricted to be registered to any of the temporal blocks 30 and beyond this, in accordance with the embodiments described herein below, they might be positioned at, and be derived from, sub-sample positions of channel 92.

The one or more reference block portions 242 may represent on the encoder side previously encoded portions and at the decoder side previously decoded portions.

In FIG. 2B, the number of reference block portions 242 is two but this number may also be one or be larger than two. In particular, the number of reference block portions 242 might be determined by the encoder 10 and signaled in the data stream 16. The number might be determined for each intra-predicted temporal block 140 individually and signaled in the data stream 16 for that segment 140 individually. Alternatively, the number is signaled in the data stream 16 at a coarser time/channel grid. For instance, the number might be signaled in the data stream 16 channel-globally, i.e. for all coded channels, with being updated intermittently such as for each temporal block 30 or for each sequence of temporal blocks 30 from a random access temporal block such as segment 30b up to the temporal block 30d immediately preceding the next random access temporal block 30e. Even alternatively, the number of reference block portions might be signaled in the data stream 16 channel-individually but for a period comprising more than just one temporal block 140 of that channel such as channel 92.

The data stream 16 might have, for each of the one or more reference block portions 242₁ and 242₂, a position 244₁, 244₂ of the respective reference block portion coded thereinto. In particular, this position might be the starting position of the respective reference block portion as depicted in FIG. 2B. As the starting position needs to be distanced from the beginning 250 of the intra-predicted temporal block 140 by at least a temporal distance 252 equaling the temporal length 254 of temporal block 140 itself, the starting position 244_{1/2} might be coded into the data stream 16 as a temporal offset 248₁ and 248₂ relative to a temporal reference position 246 lying at the temporal distance 252 ahead beginning 250.

The position 244_{1/2} may be coded into the data stream 16 at sample accuracy or at sub-sample accuracy or at an accuracy signalled in the data stream 16. According to an embodiment, it is signaled in the data stream 16 whether the position 244_{1/2} is coded into the data stream 16 at sample accuracy or sub-sample accuracy and, in case of more than one sub-sample accuracy being available, at which sub-sample accuracy. The signaling of this accuracy may, again, be done individually for the intra-predicted temporal block 140, or be done at a coarser temporal and/or channel grid. For instance, the accuracy may be signaled channel-globally, i.e. for all coded channels commonly, and in temporal terms, it may be signaled in the data stream 16 for the whole data stream 16 or for each sequence of temporal blocks 30 from a random access temporal block, e.g., see 30b, onwards up to the temporal block, e.g., see 30d, immediately preceding the next random access temporal block, e.g., see 30e, or for each temporal block 30. Even alternatively, the accuracy may be signaled channel-individually but for periods encompassing more than just one temporal block 140.

If the position of a predetermined reference block portion 242_{1/2} falls onto a sub-sample position, e.g., sub-pel position, the predetermined reference block portion 242_{1/2} is derived from channel 92 by sampling this channel 92 using an interpolation filter at a grid of sub-sample positions which grid has a temporal length of temporal block 242, i.e. has the same number of samples, and is placed at the sub-sample position 244_{1/2}.

If the number of reference block portions 242_{1/2} is larger than one, as it is the case in FIG. 2B, the prediction signal 64 of temporal block 140 may be derived based on a sum 260 of the reference block portions 242₁ and 242₂. The sum may be a weighted sum so that reference block portion 242₁ is weighted using a factor 2621 before being subject to addition 260, while reference block portion 242₂ might be weighted by a factor 2622 before being subject to addition 260. Again, the same statements on granularity of signalization as done above with respect to the position signaling holds true with respect to a signalization of one, a subset of, or all of the weights/factors 2621/2 in data stream 16, wherein the granularity may be equal to the one of the signalization of the position or different thereto. However, the weights might be set be default and, optionally, they might be equal to each other, such as the inverse of the number of reference block partitions.

Further, adaptive filtering with signaled filter coefficients might be used to filter either the weighted sum of individual weighted reference block portions, or one or more of the reference block portions before being used to form the prediction signal in combination with the other reference block portion(s). According to an embodiment, a filter index is signals in the data stream 16 for obtaining the one or more filter coefficients by accessing a look-up table using the filter index. The encoder 10 may be configured to signal in the data stream 16 filter information indicative for building the look-up table (e.g., the decoder 12 can be configured to build the look-up table based on the filter information). According to an embodiment, the adaptive filter is a FIR filter and the decoder 12/encoder 10 is configured to derive/encode a number of filter taps of the FIR filter from/into the data stream 16 and derive/encode one filter coefficient per filter tap from/into the stream 16.

Generally, and using a pseudo-code like writing, the following options for transmitting the reference block portions' offsets and the filter decision shall explicitly be mentioned (with steps in parenthesis being optional):

A)

| | |
|---|---|
| (decode/encode number of reference block portions) | (NOTE: for this temporal block |
| | individually or at a larger temporal |
| | scope) |

For each reference block portion

| | |
|---|---|
| decode/encode offset unit indicator | (NOTE: one of full-sample, half-sample |
| | units or the like) |
| decode/encode number of offset units | (NOTE: so that offset is this number times |
| | offset unit) |
| if there is no reference block portion with sub-sample offset, | (NOTE: that is, no |
| | reference block portion which |
| | requires interpolation filter) |

```
  decode/encode filter flag
if there is a reference block portion with sub-sample offset,
  infer that the filter flag indicates no filtering
if filter flag indicates filtering,
```

| | |
|---|---|
| decode/encode filter information | (NOTE: this filter might be applied to |
| | weighted sum to yield final prediction signal |
| | 64) |

B)

| | |
|---|---|
| (decode/encode number of reference block portions) | (NOTE: for this temporal block |
| | individually or at a larger temporal |
| | scope) |
| decode/encode offset unit indicator | (NOTE: one of full-sample, half-sample |
| | units or the like) |

For each reference block portion

| | |
|---|---|
| decode/encode number of offset units | (NOTE: so that offset is this number times |
| | offset unit) |
| if there is no reference block portion with sub-sample offset, | (NOTE: that is, no |
| | reference block portion which |
| | requires interpolation filter) |
| decode/encode filter flag | (NOTE: otherwise it may deemed to be |
| | none-indicative of filtering) |

if filter flag indicates filtering,

| | |
|---|---|
| decode/encode filter information | (NOTE: this filter might be applied to |
| | weighted sum to yield final prediction |
| | signal 64) |

C)

| | |
|---|---|
| (decode/encode number of reference block portions) | (NOTE: for this temporal block |
| | individually or at a larger temporal |
| | scope) |

decode/encode filter flag
if filter flag indicates filtering,

| | |
|---|---|
| decode/encode filter information | (NOTE: this filter might be applied to |
| | weighted sum to yield final prediction |
| | signal 64) |

```
  infer that offset unit indicator of each temporal block portion indicates full-sample
  offset unit
if filter flag not indicates filtering,
For each reference block portion
  if filter flag not indicates filtering,
```

| | |
|---|---|
| decode/encode offset unit indicator | (NOTE: one of full-sample, half-sample |
| | units or the like) |
| decode/encode number of offset units | (NOTE: so that offset is this number times |
| | offset unit) |

D)

| | |
|---|---|
| (decode/encode number of reference block portions) | (NOTE: for this temporal block |
| | individually or at a larger temporal |
| | scope) |

For each reference block portion

| | |
|---|---|
| decode/encode offset unit indicator | (NOTE: one of full-sample, half-sample |
| | units or the like) |
| decode/encode number of offset units | (NOTE: so that offset is this number times |
| | offset unit) |
| if respective block portion has no sub-sample offset, | (NOTE: that is, this |
| | reference block portion does not |
| | require interpolation filter) |

```
        decode/encode filter flag
        if filter flag indicates filtering,
```

| | |
|---|---|
| decode/encode filter information | (NOTE: otherwise no filtering |
| | (except interpolation filtering) takes |
| | place) |

E)

| | |
|---|---|
| (decode/encode number of reference block portions) | (NOTE: for this temporal block |
| | individually or at a larger temporal |
| | scope) |

For each reference block portion

| | |
|---|---|
| decode/encode offset unit indicator | (NOTE: one of full-sample, half-sample |
| | units or the like) |
| decode/encode number of offset units | (NOTE: so that offset is this number times |
| | offset unit) |

decode/encode filter flag
if filter flag indicates filtering,

| | |
|---|---|
| decode/encode filter information | (NOTE: this filter might be applied to |
| | weighted sum to yield final prediction |
| | signal 64) |

F)

| | |
|---|---|
| (decode/encode number of reference block portions) | (NOTE: for this temporal block |
| | individually or at a larger temporal |
| | scope) |
| decode/encode offset unit indicator | (NOTE: one of full-sample, half-sample |
| | units or the like) |

For each reference block portion

| | |
|---|---|
| decode/encode number of offset units | (NOTE: so that offset is this number times |
| | offset unit) |

decode/encode filter flag
if filter flag indicates filtering,

| | |
|---|---|
| decode/encode filter information | (NOTE: this filter might be applied to |
| | weighted sum to yield final prediction signal |
| | 64) |

G)

| | |
|---|---|
| (decode/encode number of reference block portions) | (NOTE: for this temporal block |
| | individually or at a larger temporal |
| | scope) |

For each reference block portion

| | |
|---|---|
| decode/encode offset unit indicator | (NOTE: one of full-sample, half-sample |
| | units or the like) |
| decode/encode number of offset units | (NOTE: so that offset is this number times |
| | offset unit) |

```
  decode/encode filter flag
  if filter flag indicates filtering,
```

| | |
|---|---|
| decode/encode filter information | (NOTE: otherwise no filtering |
| | (except, potentially, interpolation |
| | filtering) takes place) |

As described in FIG. 1, the data stream 16 has a prediction residual 80 encoded thereinto which forms the prediction residual of prediction signal 64 and might be used to correct prediction signal 64, such as by addition, to yield the reconstruction of temporal block 140. For example, viewing the embodiment shown in FIG. 2B, the encoder 10 may be configured to encode a prediction residual signal 80 for the current temporal block 140 into the data stream, so that the current temporal block 140 is reconstructable by correcting, using the prediction residual signal 80, a prediction signal 64 of the current temporal block 140 obtained by predicting the current temporal block 140 from the one or more reference block portions 242 of the predetermined coded channel 92. The decoder 12 may be configured to decode the prediction residual signal 80 for the current temporal block 140 from the data stream 16 and reconstruct the current temporal block 140 by correcting, using the prediction residual signal 80, a prediction signal 64 of the current temporal block 140 obtained by predicting the current temporal block 140 from the one or more (e.g. previously decoded) reference block portions 242 of the predetermined coded channel 92.

The intra-prediction described with respect to FIG. 2B might comprise features and/or functionalities as described in the following chapters or may alternatively be performed as described in one of the following chapters or as described in a combination of two or more of the following chapters, e.g., by combining features and/or functionalities as described in two or more of the following chapters.

### 2 Basic Principle of Intra Channel Prediction Using Coded Temporal Offsets

The present application deals with the coding of waveform data. Examples for these data are seismic waveform data or biomedical data such as Electroencephalography, Electromyography or Electrocardiography signals. These data might have several channels. The present application deals with prediction methods for coding that only exploit intra-channel dependencis but for which the channels can be coded independently.

Let {xᵢ} denote the sample values of a given channels which are to be coded and let {yᵢ} denote the reconstructed sample values. In the present application, the information for each channel is coded by dividing the channel in n blocks bᵢ with block sizes sᵢ, i ∈ {0,1, . . . , n−1} (e.g., see the current temporal block 140 with the temporal length 254). For the intra channel prediction with coded temporal offsets 248, e.g., see 248₁ and 248₂, the first segment with block size so is coded without any previous information. The block bᵢ 140 has its starting point 250 at the position start; and consists of the block of samples 40

[xₛₜₐᵣₜ_{ᵢ},xₛₜₐᵣₜ_{ᵢ}₊₁, . . . ,xₛₜₐᵣₜ_{ᵢ}₊ₛ_{ᵢ}₋₁]. (1)

The intra channel prediction with coded temporal offsets 248 transmits the block 140 by using prediction signals generated out of already reconstructed samples of the same channel 92 and one or several temporal offsets 248 which are coded in the bitstream 16. Such an offset 248 points to the start 244, e.g., see 244₁ and 244₂, of a block of previously coded information (e.g., a reference block portion 242, e.g., see 242₁ and 242₂) with the same length sᵢ, e.g., see 2531 and 2532, as the block bᵢ 140. Moreover, it might also be represented in a temporal sub-pel accuracy, for example in an half-pel accuracy. This means that the offset 248 can also point to temporal positions located between two points on the temporal sampling grid of the signal.

If a represents the temporal sub-pel accuracy, for example α=½, or if α=1 (in the case that there is no temporal sub-pel accuracy of the offset), in the present invention, the temporal offset belongs to the set

$$\{ {m}_{i}^{j} = max ( 0 , {start}_{i} - μ \cdot {s}_{i} ) + α \cdot j : j ∈ ℕ : m \leq {start}_{i} - {s}_{i} \} . \qquad ( 2 )$$

Given a temporal offset

$${m}_{i}^{j}$$

(according to an embodiment

$${m}_{i}^{j}$$

may represent the starting position 244 of a reference block portion 242), if

$${m}_{i}^{j}$$

points to an actual point on the temporal sampling grid, the prediction signal for the block (1), e.g., for the current temporal block 140, is computed as

$$pred ( {m}_{i}^{j} ) = [ {y}_{{m}_{i}^{j}} , {y}_{{m}_{i}^{j} + 1} , … , {y}_{{m}_{i}^{j} + {s}_{i} - 1} ] . \qquad ( 3 )$$

If

$${m}_{i}^{j}$$

(e.g., the starting position 244 of a reference block portion 242) points to a non-integral point, the prediction is given as

$$pred ( {m}_{i}^{j} ) = [ {( f * y )}_{{m}_{i}^{j}} , {( f * y )}_{{m}_{i}^{j} + 1} , … , {( f * y )}_{{m}_{i}^{j} + {s}_{i} - 1} ] . \qquad ( 4 )$$

Here, f denotes an interpolation filter corresponding to the sub-pel position of

$${m}_{i}^{j}$$

and f* y denotes the convolution of y with f.

According to an embodiment a filtering flag can be signalled in the data stream 16, e.g., encoded by the encoder 10 and decoded by the decoder 12. The decoder 12/encoder 10, for example, is configured to derive/encode, for a predetermined reference block portion (e.g., 242₁ or 242₂) of the one or more reference block portions 242, a starting position (e.g., 244₁ or 244₂) of the respective reference block portion from/into the data stream 16 by decoding/encoding from/into the data stream 16 a position syntax element being indicative of the position 244 and by forming a product between a value of the position syntax element and a temporal unit (e.g., a full-sample unit or a sub-sample unit). The filter flag, for example, indicates whether,
a) the predetermined reference block portion (e.g., 242₁ or 242₂) is to be derived by filtering the predetermined coded channel 92 using an adaptive filter with deriving the one or more filter coefficients of the adaptive filter from the data stream 16, and the temporal unit is to be inferred to be a full-sample unit, or
b) the temporal unit is to be determined from the data stream or is to be set to be a sub-sample unit and if the position (e.g., 244₁ or 244₂) of a predetermined reference block portion (e.g., 242₁ or 242₂) of the one or more reference block portions 242 falls onto a sub-pel position, the predetermined reference block portion (e.g., 242₁ or 242₂) is to be derived by sampling the predetermined coded channel 92 using an interpolation filter at a grid of sub-sample positions which has a temporal length of the current temporal block 140 and is placed at the sub-sample position.

### 3 Coding of the Temporal Offset Value

The information to transmit the specific form of the intra channel prediction with temporal offsets 248 on a given block 140 can be divided in two parts. First, similar to other prediction modes, a flag may be transmitted which signals whether the prediction mode with temporal offsets 248 is to be used. This flag is not transmitted and inferred to have the value false at the decoder 12 if the block 140 is the first block of the sequence or the first block after a random-access point 96 of the sequence.

Second, if the transmitted flag indicates that the intra channel prediction with temporal offsets 248 is to be used, the specific offset value is transmitted. For this purpose, the offset

$${m}_{i}^{j}$$

(e.g., the starting position 244 of a reference block portion 242) is represented as

$${m}_{i}^{j} = {start}_{i} - {s}_{i} - α \cdot {v}_{i}^{j}$$

and the value of

$${v}_{i}^{j}$$

(e.g., a temporal offset 248 relative to a temporal reference position 246 (e.g., startᵢ−sᵢ) which precedes a beginning 250 (e.g., startᵢ) of the current temporal block 140 (e.g., bᵢ) by a temporal distance 252 equaling a temporal length 254 (e.g., sᵢ) of

$${v}_{i}^{j} ,$$

one or multiple of the following methods may be used. First, the value

$${v}_{i}^{j}$$

can be coded with a variable length code where more bins are assigned to larger values of

$${v}_{i}^{j} .$$

This would for example be realized by a (truncated) binary or a (truncated) unary code or a combination of both of them. This incorporates that larger values of

$${v}_{i}^{j}$$

represent a greater temporal distance and thus should be less likely to represent the best offset for a temporal correlation. Moreover, in the binarization, it is explicitly used that there is an a priori maximum value for

$${v}_{i}^{j} ,$$

as can be seen from (2). Here, the value μ can be transmitted for a given sequence or part of the sequence. The existence of the maximum value can be incorporated for example into the choice of the truncation parameters when using truncated unary or truncated binary coding. Additionally, the various bins appearing in the transmission of the offset value might be coded using the method of context based binary adaptive arithmetic coding (CABAC). In another method, the value of

$${v}_{i}^{j}$$

can pe coded predictively based on already transmitted values

$${v}_{\hat{l}}^{\hat{J}} , \hat{l} < i .$$

For example, the difference to one of these values

$${v}_{\hat{l}}^{\hat{J}}$$

can be transmitted. Ine specific index î to which the difference is transmitted can itself be transmitted—for example, it might belong to a list of possible indices generated at the decoder and only an index into this list is transmitted.

The decoder 12/encoder 10, for example, is configured to decode/encode the position, e.g., 244₁ or 244₂, of a predetermined reference block portion, e.g., 242₁ or 242₂, of the one or more reference block portions 242 predictively (e.g., as a prediction residual relative to) based on a previously decoded/encoded position of a further reference block portion of the one or more reference block portions (e.g. decoding/encoding

$${v}_{i}^{j} - {v}_{i}^{\hat{J}}$$

rather than

$${v}_{i}^{j}$$

directly, or in terms of the figure, distance 248₁ minus 248₂ instead of 248₁ directly). Alternatively, the decoder 12/encoder 10, for example, is configured to decode/encode the position, e.g., 244₁ or 244₂, of a predetermined reference block portion, e.g., 242₁ or 242₂, of the one or more reference block portions 242 predictively (e.g., as a prediction residual relative to) based on a previously decoded/encoded position of a further reference block portion of one or more further reference block portions based on which (e.g., predetermined; e.g., immediately preceding) previously decoded/encoded temporal block (e.g., a preceding temporal block immediately preceding the current temporal block 140) of the predetermined coded channel 92 is predicted (e.g. decoding/encoding

$${v}_{i}^{j} - {v}_{\hat{l}}^{\hat{J}}$$

rather than

$${v}_{i}^{j}$$

directly or, in terms of the figure, distance 248₁ minus such a distance used for placing such a reference block portion for a previously encoded segment of channel 92 such as the immediately preceding one 254 instead of 248₁ directly). The decoder 12/encoder 10 may be configured to decode/encode an identifier of the previously decoded/encoded temporal block of the predetermined coded channel 92 from/into the data stream 16.

According to an embodiment, the decoder 12/encoder 10 is configured to decode/encode the position 244 of the respective reference block portion 242 from/into the data stream 16 using binary-arithmetic decoding/encoding (e.g., CABAC) of a binarization of a position syntax element being indicative of the position 244 of the respective reference block portion 242. The binarization, for example, can be selected so that a bin length of the binarization of the position syntax element monotonically increases with respect to a distance, e.g., the distance 252 plus the respective distance 248, of the position 244 of the respective reference block portion 242 from the current temporal block 140, e.g., the bin length of the binarization of the position syntax element that is indicative of the position 244₂ of the reference block portion 242₂ may be longer than the bin length of the binarization of the position syntax element that is indicative of the position 244₁ of the reference block portion 242₁. The decoder 12/encoder 10 is configured to set a binarization parameter of the binarization, so that a position maximally indicatable (e.g., a farthest away reference block portion position; e.g., a position farther away from the position 250 of the current temporal block 140 than the position maximally indicatable is not possible) using the binarization becomes closest to—with becoming equal or greater than-a maximum distance for the position from the current temporal block. For example, if the maximum distance represents 32 samples (e.g., see the distance 252+248₁ of the reference block portion 242₁) the binarization becomes equal to the maximum distance, namely 32 (2⁵). For example, if the maximum distance, for example, represents 100 samples the binarization becomes greater than the maximum distance, namely 128 (2⁷). The maximum distance is derivable from the data stream 16, e.g., en block (e.g., individually for each current temporal block 140), en channel (e.g., individually for each channel) or once for the complete multi-channel digital signal 14.

4 Signal Adaptive Prediction Filtering for Intra Channel Prediction with Temporal Offsets

It is observed that the signals to be coded might carry a lot of noise and that a periodic or locally periodic behavior of the signals can only be assumed after this noise is removed. However, a global exact modeling of the latter noise might be impossible since the characteristic of the noise might vary. Thus, in the present application, it is proposed to support a local removing of the noise by supporting a filtering of the prediction signal. Here, the filter coefficients are determined at the encoder and transmitted in the bit-stream. Thus, using the notation from (3), it is proposed to generate the prediction signal as

$$pred ( {m}_{i}^{j} ) = [ {( \tilde{f} * y )}_{{m}_{i}^{j}} , {( \tilde{f} * y )}_{{m}_{i}^{j} + 1} , … , {( \tilde{f} * y )}_{{m}_{i}^{j} + {s}_{i} - 1} ] . \qquad ( 5 )$$

This process thus is similar to (4). However, \tilde{f} denotes an FIR filter with u many taps whose coefficients are transmitted in the bit-stream. Also, the number u might be variable or at least belong to some predefined set of possible options and might be transmitted in the bit-stream. For the transmission of the filter-coefficients of \tilde{f}, one option might be to simply use the filter coefficients of a previous block which have already been transmitted. Another option might be to use filter coefficients from a predetermined set of fixed filters and to only transmit an index into this set. Another option might be to transmit the coefficients using truncated binary coding.

In this invention, it is proposed to make the prediction generation of the form (5) only optional. Thus, a flag is transmitted that indicates whether or not a process of the form (5) is to be invoked. Moreover, it is proposed to make the prediction generations of the forms (4) and (5) mutually exclusive in order to avoid the subsequent applications of two filtering operations. Thus, when a flag indicates that a prediction generation of the form (5) is to be invoked, the temporal offset value may only point to integral positions in the temporal sampling grid. This results in the saving of one bin when representing this temporal offset value for transmission.

For example, the decoder 12/encoder 10 may be configured to derive/encode, for a predetermined reference block portion (e.g., 242₁ or 242₂) of the one or more reference block portions 242, a starting position (e.g., 244₁ or 244₂) from/into the data stream 16 by decoding/encoding from/into the data stream 16 a position syntax element being indicative of the starting position 244

$$( e . g . , {m}_{i}^{j} )$$

and by forming a product

$$( e . g . , α \cdot {v}_{i}^{j} )$$

between a value

$$( e . g . , {v}_{i}^{j} )$$

of the position syntax element and a temporal unit (e.g., α; e.g., a full-sample unit or a sub-sample unit). If a filter flag indicates filtering, the decoder 12 may be configured to derive the predetermined reference block portion (e.g., 242₁ or 242₂) by filtering the predetermined coded channel 92 using an adaptive filter \tilde{f} (e.g., by filtering at least the (e.g., previously decoded/reconstructed) samples 40 of the predetermined reference block portion of the predetermined coded channel 92) with deriving the one or more filter coefficients of the adaptive filter \tilde{f} from the data stream 16, and may be configured to infer that the temporal unit is a full-sample unit. If the filter flag indicates no filtering, the decoder 12 may be configured to determine the temporal unit from the data stream 16 or set same to be a sub-sample unit and if the position (e.g., 244₁ or 244₂) of a predetermined reference block portion (e.g., 242₁ or 242₂) of the one or more reference block portions 242 falls onto a sub-pel position, derive the predetermined reference block portion (e.g., 242₁ or 242₂) by sampling the predetermined coded channel 92 using an interpolation filter f at a grid of sub-sample positions which has a temporal length of the current temporal block 140 and is placed at the sub-sample position (e.g., filtering the (e.g., previously decoded/reconstructed) samples 40 of the predetermined reference block portion 242 of the predetermined coded channel 92 with the interpolation filter f).

According to an embodiment, a number/count of the one or more reference block portions 242 of the predetermined coded channel 92 is signaled the data stream 16. If the number is one, the decoder 12 may be configured to derive (e.g. controlled by a flag signalled in the data stream 16) the one reference block portion 242 by filtering the predetermined coded channel 92 using an adaptive filter \tilde{f} (e.g., by filtering at least the (e.g., previously decoded/reconstructed) samples 40 of the one reference block portion 242) with deriving the one or more filter coefficients of the adaptive filter \tilde{f} from the data stream 16. If the number is larger than one (i.e. the one or more reference block portions 242 may represent two or more reference block portions 242), the decoder 12, for example, is configured to derive the two or more reference block portions without filtering the predetermined coded channel 92 using the adaptive filter \tilde{f}.

### 5 Superposition of Predictions Using Multiple Temporal Offsets

In this invention, it is also proposed to allow a superposition of two or more many prediction signals generated as in (3). This means that a linear combination of such individual prediction signals might be used to generate a final prediction signal. The weights in the linear combination might either be fixed or signaled in the bit stream. Moreover, as a variant, it is proposed that when a superposition of more than one predictions signals is to be used on a given block, the signal adaptive filtering of the previous section is prohibited for any of the individual prediction components in order to avoid that the noise-removing becomes an over smoothing. In another variant, it is proposed to only optionally support the filtering of the prediction signal after the superposition of the individual components i.e. to apply a signal adaptive filtering after the superposition. This has the advantage that only a single set of signal adaptive filter coefficients is to be transmitted. In another variant, it is proposed that a signal adaptive filtering implies that none of the individual temporal offsets used for the prediction may point to a non-integral position.

According to an embodiment, a number/count of the one or more (e.g. previously decoded) reference block portions 242 of the predetermined coded channel 92 is larger than one, as shown in FIG. 2B. Therefore, the one or more reference block portions 242 may represent two or more reference block portions 242. The decoder 12/encoder 10 is configured to predict the current temporal block 140 of the predetermined coded channel 92 by forming a weighted sum 260 of the two or more reference block portions 242 of the predetermined coded channel 92 and filtering the weighted sum 260 using an adaptive filter \tilde{f}. The one or more filter coefficients of the adaptive filter \tilde{f} may be signaled in the data stream 16.

According to an embodiment, a number/count of the one or more (e.g. previously decoded) reference block portions 242 of the predetermined coded channel 92 is larger than one, as shown in FIG. 2B. Therefore, the one or more reference block portions 242 may represent two or more reference block portions 242. The decoder 12/encoder 10 is configured to predict the current temporal block 140 of the predetermined coded channel 92 by, for each of the two or more reference block portions 242 of the predetermined coded channel 92, deriving respective one or more filter coefficients of an adaptive filter \tilde{f} from the data stream 16 and filtering, using the one or more filter coefficients, the respective reference block portion 242 so as to obtain a filtered reference block portion, and by forming a weighted sum 260 of the filtered reference block portions 242 of the predetermined coded channel 92.

According to an embodiment, a number/count of the one or more (e.g. previously decoded) reference block portions 242 of the predetermined coded channel 92 is larger than one and a filtering flag may be signalled in the data stream 16. Therefore, the one or more reference block portions 242 may represent two or more reference block portions 242. The decoder 12/encoder 10 may be configured to derive/encode, for each of the two or more reference block portions 242, a position 244 of the respective reference block portion 242 from/into the data stream 16 by decoding/encoding a position syntax element being indicative of the position 244 from/into the data stream 16 and forming a product

$$( e . g . , α \cdot {v}_{i}^{j} )$$

between a value

$$( e . g . , {v}_{i}^{j} )$$

of the position syntax element and a temporal unit (e.g., α; e.g., a full-sample unit or a sub-sample unit). If the filter flag indicates filtering, the decoder 12 may be configured to infer that the temporal unit is a full-sample unit for each of the two or more reference block portions 242, and may be configured to form a weighted sum 260 of the two or more reference block portions 242 of the predetermined coded channel 92 and filter the weighted sum 260 using an adaptive filter \tilde{f} with deriving the one or more filter coefficients of the adaptive filter \tilde{f} from the data stream 16. If the filter flag indicates no filtering, the decoder 12 may be configured to, for each of the two or more reference block portions 242, determine the temporal unit from the data stream 16 or set same to be a sub-sample unit, and if the position 244 of the respective reference block portion 242 of the two or more reference block portions 242 falls onto a sub-pel position, derive the respective reference block portion 242 by sampling the predetermined coded channel 92 using an interpolation filter f at a grid of sub-sample positions which has a temporal length of the current temporal block 140 and is placed at the sub-sample position (e.g., filtering the (e.g., previously decoded/reconstructed) samples 40 of the respective reference block portion 242), and form a weighted sum 260 of the reference block portions 242 of the predetermined coded channel 92 without using the adaptive filter \tilde{f}.

### Implementation Alternatives:

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are advantageously performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A decoder for decoding a multi-channel digital signal from a data stream, configured to decode coded channels representing the multi-channel digital signal from the data stream in temporal blocks by predicting a current temporal block of a predetermined coded channel from one or more reference block portions of the predetermined coded channel.

2. The decoder of claim 1, configured to decode, from the data stream, for each of the one or more reference block portions, a position of the respective reference block portion.

3. The decoder of claim 2, wherein the position is a starting position and the decoder is configured to decode the position of the respective reference block portion from the data stream as a temporal offset relative to a temporal reference position which precedes a beginning of the current temporal block by a temporal distance equaling a temporal length of the current temporal block.

4. The decoder of claim 2, configured to decode the position of the respective reference block portion from the data stream
at a sub-sample accuracy,
at sample accuracy, or
at an accuracy signalled in the data stream.

5. The decoder of claim 2, configured to, if the position of a predetermined reference block portion of the one or more reference block portions falls onto a sub-pel position, derive the predetermined reference block portion by sampling the predetermined coded channel using an interpolation filter at a grid of sub-sample positions which comprises a temporal length of the current temporal block and is placed at the sub-sample position.

6. The decoder of claim 2, configured to decode the position of a predetermined reference block portion of the one or more reference block portions predictively based on
a previously decoded position of a further reference block portion of the one or more reference block portions, or
a previously decoded position of a further reference block portion of one or more further reference block portions based on which a previously decoded temporal block of the predetermined coded channel is predicted.

7. The decoder of claim 2, configured to decode the position of a predetermined reference block portion of the one or more reference block portions predictively based on a previously decoded position of a further reference block portion of one or more further reference block portions based on which a predetermined previously decoded temporal block of the predetermined coded channel is predicted,
wherein the decoder is configured to decode an identifier of the predetermined previously decoded temporal block of the predetermined coded channel from the data stream.

8. The decoder of claim 2, configured to
decode the position of the respective reference block portion from the data stream using binary-arithmetic decoding of a binarization of a position syntax element being indicative of the position, wherein the binarization is selected so that a bin length of the binarization of the position syntax element monotonically increases with respect to a distance of the position from the current temporal block, and
set a binarization parameter of the binarization so that a position maximally indicatable using the binarization becomes closest to a maximum distance for the position from the current temporal block.

9. The decoder of claim 8, configured to derive the maximum distance from the data stream.

10. The decoder of claim 1,
wherein the multi-channel digital signal is acquired by at least one of Electrocardiography, Electroencephalography, Electromyography or seismic measurement, and/or
wherein the multi-channel digital signal is a bio-physiological waveform data such as an electroencephalography signal, an electrocardiogram, or an electromyography signal, or seismic waveform data.

11. The decoder of claim 1, configured to
support different segment coding modes comprising an inter prediction coding mode and an intra prediction coding mode,
decode a mode indicator for the current temporal block from the data stream and
if the mode indicator is indicative of the intra prediction mode,
perform the predicting the current temporal block of the predetermined coded channel from the one or more reference block portions of the predetermined coded channel, and
if the mode indicator is indicative of the inter prediction mode,
determine one or more prediction parameters for predicting the current temporal block of the predetermined coded channel based on a reference block portion of a set of one or more reference channels of the coded channels based on a preceding temporal block of the predetermined coded channel and a preceding temporal reference block of the one or more reference channels, and
predict the current temporal block of the predetermined coded channel from the reference block portion of the one or more reference channels using the one or more prediction parameters.

12. The decoder of claim 11, configured to, if the current temporal block forms a random access point of the data stream, skip the decoding the mode indicator and infer that the mode indicator does not indicate the intra prediction mode.

13. The decoder of claim 1, configured to decode the coded channels from the data stream in the temporal blocks by sequentially decoding from the data stream a predetermined temporal block of each of the coded channels before decoding a subsequent temporal block of any of the coded channels.

14. The decoder of claim 13, wherein the temporal blocks are temporally aligned among the coded channels so that mutually co-located temporal blocks of the coded channels commonly start at a predetermined time instant and end at a further predetermined time instant at which the subsequent temporal segment of the coded channels start.

15. The decoder of claim 1, configured to support different lengths of the temporal blocks and set a length of the temporal blocks according to a length parameter in the data stream.

16. The decoder of claim 1, configured to support different lengths of the temporal blocks and switch between the different lengths of the temporal blocks at predetermined borders between consecutive temporal blocks according to a length parameter in the data stream.

17. The decoder of claim 1, configured to decode a prediction residual signal for the current temporal block from the data stream and reconstruct the current temporal block by correcting, using the prediction residual signal, a prediction signal of the current temporal block acquired by the predicting the current temporal block from the one or more reference block portions of the predetermined coded channel.

18. The decoder of claim 1, configured to derive one or more predetermined reference block portions of the one or more reference block portions by filtering the predetermined coded channel using an adaptive filter, and
derive one or more filter coefficients of the adaptive filter from the data stream.

19. The decoder of claim 18, configured to derive the one or more filter coefficients of the adaptive filter from the data stream by decoding a filter index from the data stream and using the filter index in order to acquire the one or more filter coefficients by accessing a look-up table using the filter index.

20. The decoder of claim 19, configured to build the look-up table based on filter information signalled in the data stream.

21. The decoder of claim 18, wherein the adaptive filter is a FIR filter and the decoder is configured to derive a number of filter taps of the FIR filter from the data stream and derive one filter coefficient per filter tap from the stream.

22. The decoder of claim 1, configured to
decode a filtering flag from the data stream,
derive, for a predetermined reference block portion of the one or more reference block portions, a position of the respective reference block portion from the data stream by decoding a position syntax element being indicative of the position from the data stream and forming a product between a value of the position syntax element and a temporal unit,
if the filter flag indicates filtering,
derive the predetermined reference block portion by filtering the predetermined coded channel using an adaptive filter with deriving the one or more filter coefficients of the adaptive filter from the data stream, and
infer that the temporal unit is a full-sample unit, and
if the filter flag indicates no filtering,
determine the temporal unit from the data stream or set same to be a sub-sample unit and if the position of a predetermined reference block portion of the one or more reference block portions falls onto a sub-pel position, derive the predetermined reference block portion by sampling the predetermined coded channel using an interpolation filter at a grid of sub-sample positions which comprises a temporal length of the current temporal block and is placed at the sub-sample position.

23. The decoder of claim 1, wherein a number of the one or more reference block portions of the predetermined coded channel is larger than one and the decoder is configured to predict the current temporal block of the predetermined coded channel based on a weighted sum of the reference block portions of the predetermined coded channel.

24. The decoder of claim 23, configured to derive one or more weights of the weighted sum from the data stream.

25. The decoder of claim 23, configured to
derive a number of the one or more reference block portions of the predetermined coded channel from the data stream,
if the number is one,
derive the one reference block portion of the reference block portions by filtering the predetermined coded channel using an adaptive filter with deriving the one or more filter coefficients of the adaptive filter from the data stream, and
if the number is larger than one,
derive the one or more reference block portions without filtering the predetermined coded channel using the adaptive filter.

26. The decoder of claim 1, wherein a number of the one or more reference block portions of the predetermined coded channel is larger than one and the decoder is configured to predict the current temporal block of the predetermined coded channel by forming a weighted sum of the reference block portions of the predetermined coded channel and filtering the weighted sum using an adaptive filter with deriving the one or more filter coefficients of the adaptive filter from the data stream.

27. The decoder of claim 1, wherein a number of the one or more reference block portions of the predetermined coded channel is larger than one and the decoder is configured to
decode a filtering flag from the data stream,
derive, for each of the one or more reference block portions, a position of the respective reference block portion from the data stream by decoding a position syntax element being indicative of the position from the data stream and forming a product between a value of the position syntax element and a temporal unit,
if the filter flag indicates filtering,
infer that the temporal unit is a full-sample unit for each of the one or more reference block portions, and
form a weighted sum of the reference block portions of the predetermined coded channel and filtering the weighted sum using an adaptive filter with deriving the one or more filter coefficients of the adaptive filter from the data stream, and
if the filter flag indicates no filtering,
for each of the one or more temporal blocks, determine the temporal unit from the data stream or set same to be a sub-sample unit and if the position of the respective reference block portion of the one or more reference block portions falls onto a sub-pel position, derive the respective reference block portion by sampling the predetermined coded channel using an interpolation filter at a grid of sub-sample positions which comprises a temporal length of the current temporal block and is placed at the sub-sample position, and
form a weighted sum of the reference block portions of the predetermined coded channel without using the adaptive filter.

28. The decoder of claim 1, wherein a number of the one or more reference block portions of the predetermined coded channel is larger than one and the decoder is configured to predict the current temporal block of the predetermined coded channel by
for each of the reference block portions of the predetermined coded channel, derive respective one or more filter coefficients of an adaptive filter from the data stream and filtering, using the one or more filter coefficients and the adaptive filter, the respective reference block portions so as to acquire a filtered reference block portion, and
forming a weighted sum of the filtered reference block portions of the predetermined coded channel.

29. An encoder for encoding a multi-channel digital signal into a data stream, configured to encode coded channels representing the multi-channel digital signal into the data stream in temporal blocks by predicting a current temporal block of a predetermined coded channel from one or more reference block portions of the predetermined coded channel.

30. A method for decoding a multi-channel digital signal from a data stream comprising decoding coded channels representing the multi-channel digital signal from the data stream in temporal blocks by predicting a current temporal block of a predetermined coded channel from one or more reference block portions of the predetermined coded channel.

31. A method for encoding a multi-channel digital signal into a data stream comprising encoding coded channels representing the multi-channel digital signal into the data stream in temporal blocks by predicting a current temporal block of a predetermined coded channel from one or more reference block portions of the predetermined coded channel.

32. The data stream generated by an encoder according to claim 29.
